(19) United States
(12) Patent Application Publication
(10) Pub. No.: US 2012/0130633 A1
(43) Pub. Date: May 24, 2012

(54) POSITIONING SYSTEM AND METHOD OF ELECTRONIC DEVICE

(75) Inventor: YING-CHUAN TSAI, Tu-Cheng (TW)

(73) Assignee: HON HAI PRECISION INDUSTRY CO., LTD., Tu-Cheng (TW)

(21) Appl. No.: 13/272,233

(22) Filed: Oct. 13, 2011

(30) Foreign Application Priority Data
Nov. 23, 2010 (TW) 099140290

(51) Int. Cl. G01C 21/00

(52) U.S. Cl. 701/454

(57) ABSTRACT

In a positioning system and method using an electronic device, the electronic device and target electronic devices communicate with each other in a geographic region. Geographic location of the electronic device is located using a global positioning system of the electronic device. The geographic location of the electronic device is regularly transmitted to each of the target electronic devices. Geographic location of each of the target electronic devices is recorded in a storage system of the electronic device and can be updated according to received location data from the target electronic devices. An electronic map is displayed on a display screen of the electronic device, and the geographic location of the electronic device and the geographic location of each of the target electronic devices are marked on the electronic map.

### BACKGROUND

1. Technical Field

Embodiments of the present disclosure relate generally to positioning, and more particularly, to a positioning system and method of an electronic device.

2. Description of Related Art

A global positioning system (GPS) receiver of an electronic device can determine a geographic location of the electronic device, and the geographic location can be marked on an electronic map that displays on the electronic device in real-time. A user of the electronic device can get the geographic location from the electronic map. However, if the user travels with friends, the user cannot get a geographic location of each friend from the electronic map directly. What is needed, therefore, is a positioning method of an electronic device to overcome the limitations described.

### BRIEF DESCRIPTION OF THE DRAWINGS

FIG. 1 is a block diagram of one embodiment of an electronic device including a positioning system.

FIG. 2 is a schematic diagram of one embodiment of a predetermined group.

FIG. 3 is a block diagram of one embodiment of functional modules of the positioning system included in the electronic device of FIG. 1.

FIG. 4 is a flowchart of one embodiment of a positioning method of the electronic device in FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

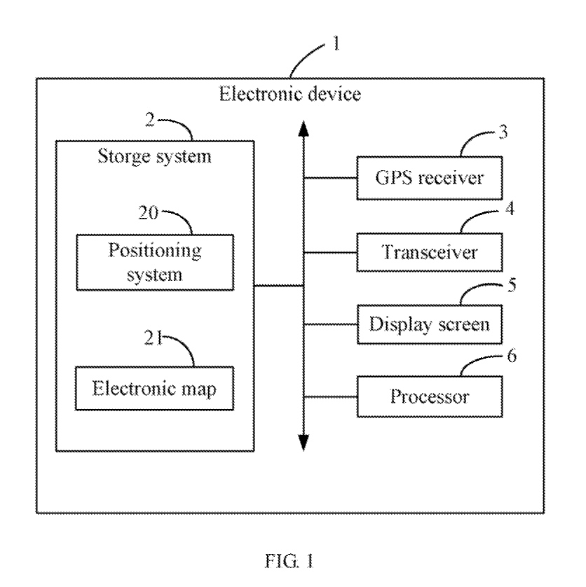

FIG. 1 is a block diagram of one embodiment of an electronic device 1 including a positioning system 20. Depending on the embodiment, the positioning system 20 is implemented by the electronic device 1, and is used for finding geographic locations of the electronic device 1 and one or more target electronic devices in a geographic region. The electronic device 1 may be a mobile phone, a personal digital assistant (PDA), a handheld game console, a digital camera (DC), a handheld computer, or a notebook computer. In the embodiment, each of the target electronic devices has the same configuration or substantially the same configuration as the electronic device 1.

In the embodiment, the electronic device 1 includes a storage system 2, a global positioning system (GPS) receiver 3, a transceiver 4, a display screen 5, and at least one processor 6. The positioning system 20 may be in the form of one or more programs that stored in the storage system 2. The storage system 2 further stores an electronic map 21. It should be apparent that FIG. 1 is just one example of the electronic device 1 that can be included with more or fewer components than shown in other embodiments, or a different configuration of the various components.

The GPS receiver 3 continually receives GPS satellite signals, and determines a geographic location of the electronic device 1 according to the GPS satellite signals of the geographic region. In the embodiment, the GPS receiver 3 can determine the geographic location of the electronic device 1 by collecting the GPS satellite signals of the geographic region. The GPS satellite signals may indicate longitude and latitude information of the geographic region.

The transceiver 4 is operable to transmit and receive data via radio waves in the geographic region. In the embodiment, the target electronic devices are located in the geographic region. Each of the target electronic devices and the electronic device 1 can communicate with each other in the geographic region by transmitting and receiving data using the respective transceiver 4.

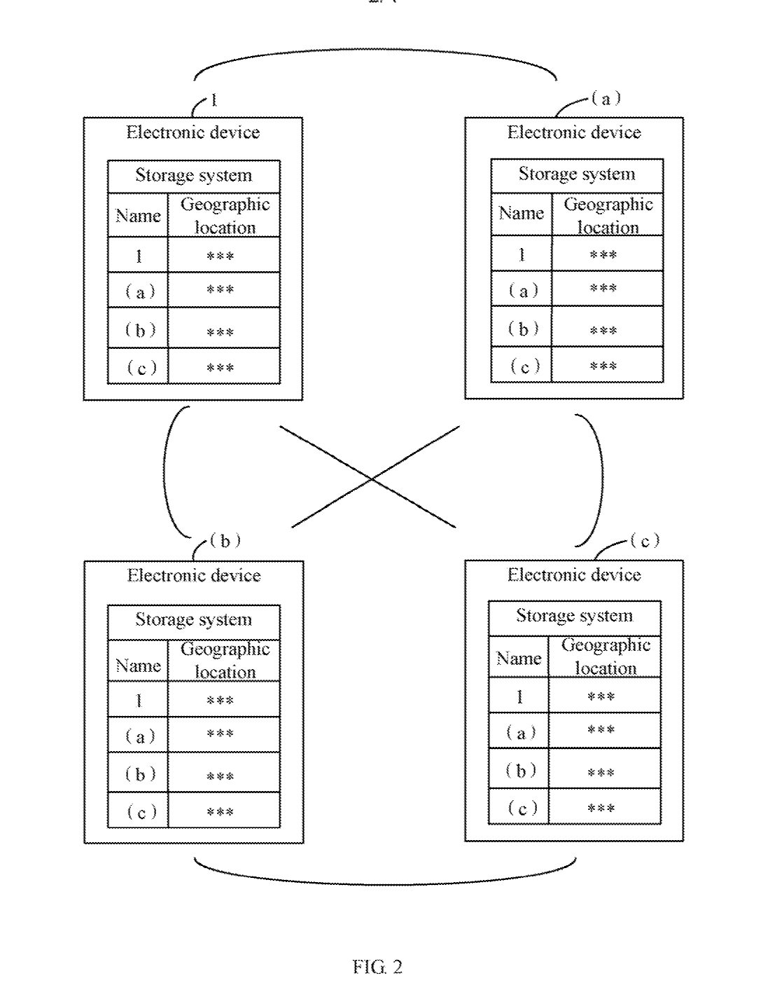

The positioning system 20 can group the electronic device 1 and the target electronic devices into a predetermined group. In one example, as shown in FIG. 2, the electronic device 1 and three target electronic devices, such as electronic device (a)-(c), are grouped into the predetermined group. The storage system 2 further records a name and the geographic location of the electronic device 1, and a name and a geographic location of each of the target electronic devices. The geographic location of the electronic device 1 and the geographic location of each of the target electronic devices are recorded as default values in the storage system 2 when the electronic device 1 starts.

The display screen 5 is operable to display the electronic map 21, and mark the geographic location of the electronic device 1 and the geographic location of each of the target electronic devices on the electronic map 21.

The storage system 2 stores one or more programs, such as an operating system, and other application of the electronic device 1. In one embodiment, the storage system 2 may be random access memory (RAM) for temporary storage of information, and/or a read only memory (ROM) for permanent storage of information. In other embodiments, the storage system 2 may also be an external storage device, such as a hard disk, a storage card, or a data storage medium. The at least one processor 6 executes computerized operations of the electronic device 1 and other applications, to provide functions of the electronic device 1.

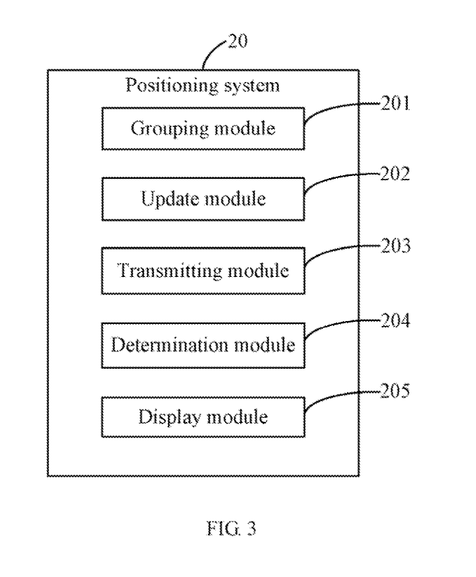

FIG. 3 is a block diagram of one embodiment of functional modules of the positioning system 20 included in the electronic device 1 of FIG. 1. The positioning system 20 may include a plurality of functional modules each comprising one or more programs or computerized codes that can be accessed and executed by the at least one processor 6. The positioning system 20 may include a grouping module 201, an update module 202, a transmitting module 203, a determination module 204, and a display module 205. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The grouping module 201 is operable to group the electronic device 1 and the target electronic devices into the predetermined group, and assign a unique identifier for the predetermined group. The target electronic devices are selected by users using the electronic device 1.

The update module 202 is operable to locate the geographic location of the electronic device 1 using the GPS receiver 3, and update the geographic location of the electronic device 1, in the storage system 2, in real-time.

The transmitting module 203 is operable to regularly generate location data according to the geographic location of the electronic device 1, and transmit the generated location data to each of the target electronic devices via the transceiver 4. The generated location data may include the identifier of the predetermined group and the geographic location of the electronic device 1. For example, after the electronic device 1 starts, the transmitting module 203 generates location data and transmits the generated location data to each of the target electronic devices every two seconds.

The determination module 204 is operable to determine whether a received location data is from one of the target electronic devices when the location data is received via the transceiver 4. If the received location data includes the identifier of the predetermined group, the determination module 204 determines that the received location data is from one of the target electronic devices, and the received location data further includes a geographic location of the one of the target electronic devices. If the received location data does not include the identifier of the predetermined group, the determination module 204 determines that the received location is not from one of the target electronic devices.

The update module 202 is further operable to update the geographic location of the one of the target electronic devices recorded in the storage system 2 when the received location data is from one of the target electronic devices.

The display module 205 is operable to display the electronic map 21 on the display screen 6, and mark the geographic location of the electronic device 1 and the geographic location of each of the target electronic devices on the electronic map 21.

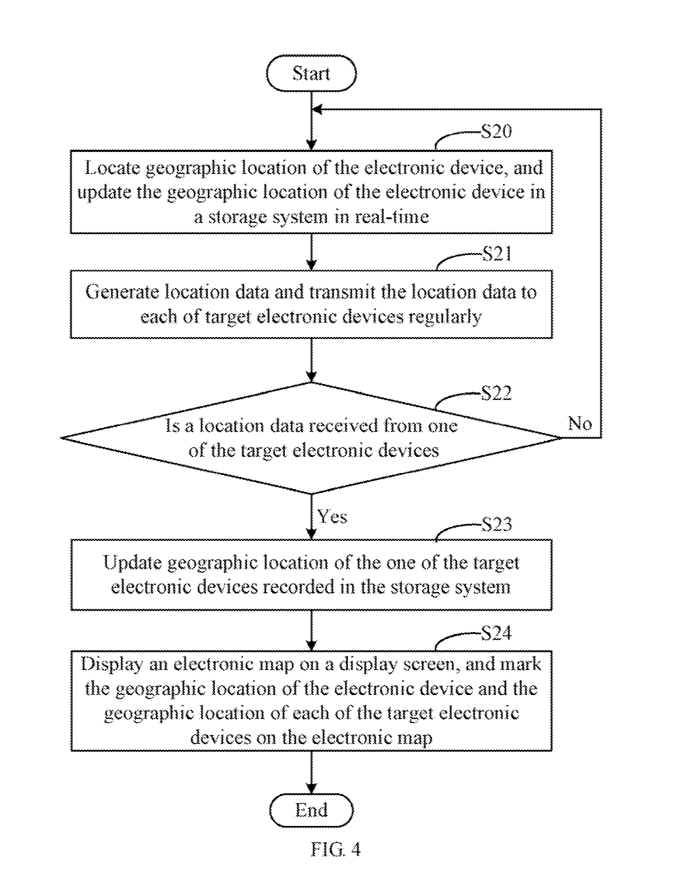

FIG. 4 is a flowchart of one embodiment of a positioning method of the electronic device 1 in FIG. 1. Depending on the embodiment, additional blocks may be added, others removed, and the ordering of the blocks may be changed. Before block S20, the grouping module 201 groups the electronic device 1 and the target electronic devices into a predetermined group, and assigns a unique identifier for the predetermined group.

In block S20, the update module 202 locates the geographic location of the electronic device 1 using the GPS receiver 3, and updates the geographic location of the electronic device 1, in the storage system 2, in real-time.

In block S21, the transmitting module 203 regularly generates location data according to the geographic location of the electronic device 1, and transmits the generated location data to each of the target electronic devices via the transceiver 4. The generated location data may include the identifier of the predetermined group and the geographic location of the electronic device 1.

In block S22, the determination module 204 determines whether a received location data is from one of the target electronic devices when the location data is received via the transceiver 4. If the received location data includes the identifier of the predetermined group, the determination module 204 determines that the received location data is from one of the target electronic devices, the received location data further includes a geographic location of the one of the target electronic devices, and block S23 is implemented. If the received location data does not include the identifier of the predetermined group, the determination module 204 determines that the received location is not from one of the target electronic devices, and block S20 is implemented.

In block S23, the update module 202 updates the geographic location of the one of the target electronic devices recorded in the storage system 2.

In block S24, the display module 205 displays the electronic map 21 on the display screen 6, and marks the geographic location of the electronic device 1 and the geographic location of each of the target electronic devices on the electronic map 21.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor;
a global positioning system (GPS) receiver operable to determine a geographic location of the electronic device;
a transceiver operable to transmit and receive data via radio waves in a geographic region of the electronic device; and
one or more programs stored in the storage system and executable by the at least one processor, the one or more programs comprising:
a grouping module operable to group the electronic device and one or more target electronic devices into a predetermined group, each of the target electronic devices and the electronic device in communication with each other in the geographic region by transmitting and receiving data using the respective transceiver of each of the target electronic devices;
an update module operable to locate the geographic location of the electronic device using the GPS receiver, and update the geographic location of the electronic device, in the storage system, in real-time;
a transmitting module operable to generate location data and transmit the location data to each of the target electronic devices via the transceiver regularly;
a determination module operable to determine whether a received location data is from one of the target electronic devices when the location data is received via the transceiver;
the update module further operable to update the geographic location of the one of the target electronic devices recorded in the storage system according to the received location data when the received location data is from one of the target electronic devices;
a display module operable to display an electronic map on a display screen of the electronic device, and mark the geographic location of the electronic device and the geographic location of each of the target electronic devices on the electronic map.

2. The electronic device of claim 1, wherein the geographic location of the electronic device and the geographic location of each of the target electronic devices are recorded as default values in the storage system when the electronic device starts.

3. The electronic device of claim 1, wherein the grouping module is further operable to assign a unique identifier for the predetermined group.

4. The electronic device of claim 3, wherein the generated location data comprises the identifier of the predetermined group and the geographic location of the electronic device.

5. The electronic device of claim 4, wherein the determination module determines that the received location data is from one of the target electronic devices, upon the condition that the received location data includes the identifier of the predetermined group, or determines that the received location data is not from one of the target electronic devices, upon the condition that the received location data does not include the identifier of the predetermined group.

6. A positioning method of an electronic device, the electronic device comprising a transceiver, the method comprising:
(a) grouping the electronic device and one or more target electronic devices into a predetermined group, each of the target electronic devices and the electronic device in communication with each other in a geographic region of the electronic device by transmitting and receiving data using the respective transceiver of each of the target electronic devices;
(b) locating the geographic location of the electronic device using a global positioning system receiver of the electronic device, and updating the geographic location of the electronic device, in the storage system, in real-time;
(c) generating location data and transmitting the location data to each of the target electronic devices via the transceiver regularly;
(d) determining whether a received location data is from one of the target electronic devices when the location data is received via the transceiver;
(e) updating the geographic location of the one of the target electronic devices recorded in the storage system according to the received location data when the received location data is from one of the target electronic devices;
(f) displaying an electronic map on a display screen of the electronic device, and marking the geographic location of the electronic device and the geographic location of each of the target electronic devices on the electronic map.

7. The method of claim 6, wherein the geographic location of the electronic device and the geographic location of each of the target electronic devices are recorded as default values in the storage system when the electronic device starts.

8. The method of claim 6, wherein the block (a) further comprises:
assigning a unique identifier for the predetermined group.

9. The method of claim 8, wherein the generated location data comprises the identifier of the predetermined group and the geographic location of the electronic device.

10. The method of claim 9, wherein the block (d) further comprises:
determining that the received location data is from one of the target electronic devices, upon the condition that the received location data includes the identifier of the predetermined group; or
determining that the received location data is not from one of the target electronic devices, upon the condition that the received location data does not include the identifier of the predetermined group.

11. A non-transitory storage medium storing a set of instructions, the set of instructions capable of being executed by a processor of an electronic device, cause the electronic device to execute a positioning method, the electronic device comprising a transceiver, the method comprising:
(a) grouping the electronic device and one or more target electronic devices into a predetermined group, each of the target electronic devices and the electronic device in communication with each other in a geographic region of the electronic device by transmitting and receiving data using the respective transceiver of each of the target electronic devices;
(b) locating the geographic location of the electronic device using a global positioning system receiver of the electronic device, and updating the geographic location of the electronic device, in the storage system, in real-time;
(c) generating location data and transmitting the location data to each of the target electronic devices via the transceiver regularly;
(d) determining whether a received location data is from one of the target electronic devices when the location data is received via the transceiver;
(e) updating the geographic location of the one of the target electronic devices recorded in the storage system according to the received location data when the received location data is from one of the target electronic devices;
(f) displaying an electronic map on a display screen of the electronic device, and marking the geographic location of the electronic device and the geographic location of each of the target electronic devices on the electronic map.

12. The medium of claim 11, wherein the geographic location of the electronic device and the geographic location of each of the target electronic devices are recorded as default values in the storage system when the electronic device starts.

13. The medium of claim 11, wherein the block (a) further comprises:
assigning a unique identifier for the predetermined group.

14. The medium of claim 13, wherein the generated location data comprises the identifier of the predetermined group and the geographic location of the electronic device.

15. The medium of claim 14, wherein the block (d) further comprises:
determining that the received location data is from one of the target electronic devices, upon the condition that the received location data includes the identifier of the predetermined group; or
determining that the received location data is not from one of the target electronic devices, upon the condition that the received location data does not include the identifier of the predetermined group.
